(19) United States
(12) Patent Application Publication
(10) Pub. No.: US 2021/0012546 A1
(43) Pub. Date: Jan. 14, 2021

(54) AUTOMATIC FAULT DETECTION IN HYBRID IMAGING

(71) Applicant: KONINKLIJKE PHILIPS N.V., EINDHOVEN (NL)

(72) Inventors: Herfried Karl WIECZOREK, AACHEN (DE); Andreas GOEDICKE, AACHEN (DE)

(21) Appl. No.: 17/040,835

(22) PCT Filed: Mar. 25, 2019
(86) PCT No.: PCT/EP2019/057352

§ 371 Date: Sep. 23, 2020

Related U.S. Application Data
(60) Provisional application No. 62/647,939, filed on Mar. 26, 2018.

(51) Int. Cl. G06T 11/00

(52) U.S. Cl. CPC G06T 11/008; G06T 2207/30004; G06T 2207/10104; G06T 11/005

(57) ABSTRACT

An imaging system (10) includes a first imaging device (12); a second imaging device (14) of a different modality than the first imaging device; a display device (24); and at least one electronic processor (20) programmed to: operate the first imaging device to acquire first imaging data of a subject; operate the second imaging device to acquire second imaging data of the subject; compare the first imaging data and the second imaging data to detect a possible fault in the second imaging device; and control the display device to present an alert indicating the possible fault in the second imaging device in response to the detection of the possible fault in the second imaging device.

### FIELD

The following relates generally to the medical imaging arts, emission imaging arts, positron emission tomography (PET) imaging arts, single photon emission computed tomography (SPECT) imaging arts, computed tomography (CT) imaging arts, magnetic resonance (MR) imaging arts, medical image interpretation arts, image reconstruction arts, and related arts.

### BACKGROUND

In hybrid PET/CT or PET/MR imaging, the CT or MR is used to generate an attenuation map that is then used to perform attenuation correction as part of the PET imaging data reconstruction. The attenuation map is derived from the CT image by adjusting for the difference in stopping power for 511 keV in PET versus X-rays in CT. In MR, attenuation map creation is complicated by the fundamentally different contrast mechanism of MRI compared with PET. One approach is to map the MR image to an anatomical atlas and use attenuation values of mapped tissues. SPECT/CT and SPECT/MR are similarly implemented, with the attenuation map from CT or MR used to provide an attenuation map that is used in the SPECT imaging data reconstruction.

A potential problem arises in that the user analyzes the attenuation-corrected PET image. Hence, an error in the underlying attenuation map might not be recognized. A defect in the attenuation map could produce artifacts in the attenuation-corrected PET image, potentially leading to misidentification or missed lesions or other clinical errors. Likewise, an error in the PET emission map (that is, the PET image that would be reconstructed if attenuation correction is not performed) could be masked by the attenuation correction. An error in the PET emission map could be detected by studying the PET image reconstructed without attenuation correction; again, however, the user typically does not do this.

Tomographic imaging methods like PET, CT, and MR require a full data set for correct image reconstruction. If parts of a detector ring do not work the effect may remain unnoticed when iterative image reconstruction is used, especially if a priori knowledge is incorporated into the reconstruction by way of edge-preserving regularization, an image prior, or so forth. The issue can be more severe in hybrid imaging, e.g. PET/CT or PET/MR with use of MR attenuation, when the reconstructed emission image is based on a faulty attenuation map. The reason for faulty attenuation or emission maps may be wrong classification (head/lungs/body) by the technician, used as input for atlas based reconstruction, or simply a non-functioning part of a PET ring. Such faulty input leads to image artefacts that may be recognized as lesions.

The following discloses new and improved systems and methods to overcome these problems.

### SUMMARY

In one disclosed aspect, an imaging system includes a first imaging device; a second imaging device of a different modality than the first imaging device; a display device; and at least one electronic processor programmed to: operate the first imaging device to acquire first imaging data of a subject; operate the second imaging device to acquire second imaging data of the subject; compare the first imaging data and the second imaging data to detect a possible fault in the second imaging device; and control the display device to present an alert indicating the possible fault in the second imaging device in response to the detection of the possible fault in the second imaging device.

In another disclosed aspect, an imaging system includes an imaging device comprising radiation detectors; a display device; and at least one electronic processor programmed to: operate the imaging device to acquire imaging data of a subject; analyze the imaging data of the subject respective to variability in imaging data acquired by different radiation detectors of the imaging device to detect a possible fault in the imaging device; and control the display device to present an alert indicating a possible fault in the imaging device in response to detection of the possible fault in the imaging device.

In another disclosed aspect, an imaging method includes: receiving imaging data of a subject; using an electronic processor, analyzing variability of the imaging data amongst the radiation detectors of the imaging device to detect a possible fault in the imaging device; and displaying an alert on a display device indicating the possible fault in the imaging device in response to detection of the possible fault in the imaging device.

In another disclosed aspect, a non-transitory storage medium stores instructions readable and executable by at least one electronic processor operatively connected with a display device to perform an imaging method. The method includes: without performing attenuation correction, reconstructing emission imaging data acquired of a subject to generate a reference attenuation map; comparing the reference attenuation map with an attenuation map to be used in reconstructing the emission imaging data to generate a clinical image to detect a possible fault in the attenuation map; and conditional upon the comparing detecting the possible fault in the attenuation map, displaying an alert on the display device indicating the possible fault in the attenuation map.

In another disclosed aspect, a non-transitory storage medium stores instructions readable and executable by at least one electronic processor operatively connected with a display device to perform an imaging method. The method includes: without performing attenuation correction, reconstructing emission imaging data acquired of a subject to generate a reference attenuation map; and simultaneously displaying on the display device both the reference attenuation map and an attenuation map to be used in reconstructing the emission imaging data to generate a clinical image.

One advantage resides in detecting faults in imaging devices.

Another advantage resides in detecting faults in hardware of imaging systems.

Another advantage resides in detecting faults in image analysis operations of imaging systems.

Another advantage resides in detecting faults in hybrid imaging systems.

Another advantage resides in providing a consistency check on an attenuation map employed in hybrid emission/CT or emission/MR imaging.

Another advantage resides in providing a data variability check on imaging data to detect imaging device faults that could lead to compromised clinical images.

Another advantage resides in facilitating visual verification of an attenuation map prior to its use in attenuation correction of reconstruction of emission imaging data.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically shows an imaging system according to one aspect; and

FIGS. 2-5 show exemplary flow chart operations of the system of FIG. 1.

### DETAILED DESCRIPTION

Disclosed improvements provide automated data quality/consistency checks to detect potential problems in one or more constituent imaging modalities.

In some embodiments, an emission map check can be performed based on the expectation that all detectors of a single PET ring should detect about the same total or average counts. Variability amongst the detectors can be quantified by calibration runs for a given imaging setup, and if an unexpectedly large variability over a single PET ring is detected then a warning can be issued that the PET emission map is suspect. Similar checks can be performed between rings, e.g. in a multi-station imaging sequence each PET detector ring should detect the same average emission summed over the ring when the ring is at a given axial position respective to the patient. In the case of SPECT, similar uniformities should be observed, and excessive variations compared with a calibration standard can be detected and a warning issued.

To check the attenuation map, one approach is to reconstruct the uncorrected PET image and to derive an approximate attenuation map. For example, approaches for deriving an approximate attenuation map disclosed in Salomon et al., “Apparatus and Method for Generation of Attenuation Map”, U.S. Pub. No. 2011/0007958, which is incorporated herein by reference in its entirety, may be used. The attenuation map derived from the uncorrected PET image is compared with an attenuation map derived from the CT or MR image to detect a large-scale error in the latter. In the case of CT, such a large-scale error is most likely to be due to failure of one or a group of CT detector modules. In the case of MR, the most likely source of large-scale error is selection of the wrong anatomical atlas when converting the MR image to an attenuation map, although other thusly detectable large scale errors could be present due to MRI system malfunctions.

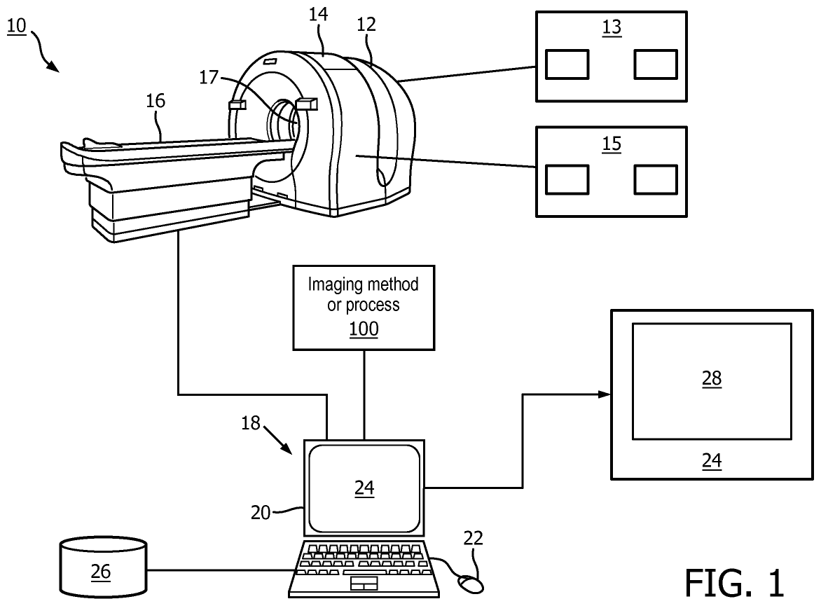

With reference to FIG. 1, an illustrative medical imaging system 10 is shown. As shown in FIG. 1, the system 10 includes a first imaging or image acquisition device 12. In one example, the image acquisition device 12 can comprise a PET imaging device including a PET gantry and an array of radiation detectors 13 (diagrammatically indicated in FIG. 1; typically, the radiation detectors of the PET gantry are arranged as a series of PET detector rings arranged to span an axial FOV). In another example, the first imaging device 12 can comprise a gamma camera of a SPECT imaging device, e.g. including one, two, three, or more radiation detector heads each arranged on a robotic gantry to move around the patient to provide tomographic data, and each radiation detector head of the gamma camera typically having a honeycomb collimator or other type of collimator to limit the vantage of the radiation detectors to lines or narrow-angle conical fields of view. The imaging system 10 also includes a second imaging or image acquisition device 14 that is of a different modality than the first imaging device 12. In one example, the second imaging device 14 can comprise a CT gantry and array of radiation detectors 15 (diagrammatically indicated in FIG. 1). In another example, the second imaging device 14 can comprise a MR imaging device. A patient table (or bed) 16 is arranged to load a patient into an examination region 17 of the first imaging device 12 or the second imaging device 14.

The system 10 also includes a computer or workstation or other electronic data processing device 18 with typical components, such as at least one electronic processor 20, at least one user input device (e.g., a mouse, a keyboard, a trackball, and/or the like) 22, and a display device 24. In some embodiments, the display device 24 can be a separate component from the computer 18, and/or may comprise two or more displays. The workstation 18 can also include one or more databases or non-transitory storage media 26 (such as a magnetic disk, RAID, or other magnetic storage medium; a solid state drive, flash drive, electronically erasable read-only memory (EEROM) or other electronic memory; an optical disk or other optical storage; various combinations thereof; or so forth). The display device 24 is configured to display images acquired by the imaging system 10 and typically also to display a graphical user interface (GUI) 28 including various user dialogs, e.g. each with one or more fields, radial selection buttons, et cetera to receive a user input from the user input device 22.

The at least one electronic processor 20 is operatively connected with the one or more databases 26 which stores instructions which are readable and executable by the at least one electronic processor 20 to perform disclosed operations including performing an imaging method or process 100. In some examples, the imaging method or process 100 may be performed at least in part by cloud processing.

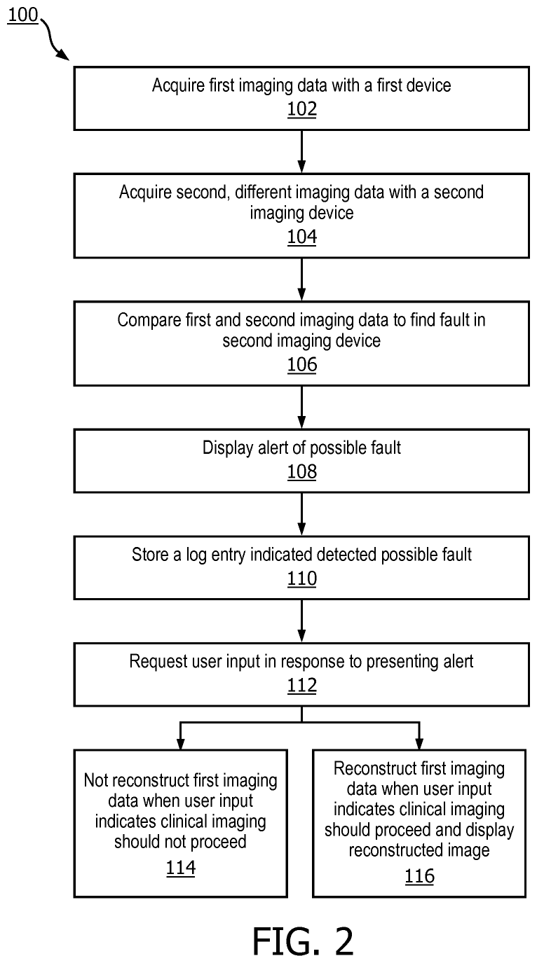

With reference to FIG. 2, an illustrative embodiment of a multi-modality imaging embodiment of the imaging method 100 is diagrammatically shown as a flowchart, including aspects well suited for detecting a fault in the attenuation map. At 102, the at least one electronic processor 20 is programmed to control or operate the first imaging device 12 to acquire first imaging data of a subject. In another example, the at least one electronic processor 20 is programmed to receive the first imaging data from an associated first imaging device. At 104, the at least one electronic processor 20 is programmed to control or operate the second imaging device 14 to acquire second imaging data of a subject (i.e., so that there are two different image sets of the subject of different modalities). In another example, the at least one electronic processor 20 is programmed to receive the second imaging data from an associated second imaging device. For example, the first imaging data can comprises emission imaging data of the subject, and the second imaging data comprises CT or MRI imaging data of the subject.

At 106, the at least one electronic processor 20 is programmed to compare the first imaging data and the second imaging data to detect a possible fault in the second imaging device 14. In one embodiment, the at least one electronic processor 20 is programmed to reconstruct the emission imaging data (i.e. first imaging data) without attenuation correction to generate a reference attenuation map of the subject, and to derive an attenuation map of the subject from the CT or MRI imaging data. In the case of CT, the attenuation map is suitably derived by reconstructing the CT imaging data into a CT image and scaling the intensities of the CT image to account for the difference in photon energy between the X-rays used in CT imaging compared with the 511 keV gamma rays used in PET (or compared with the energies of gamma rays detected in SPECT imaging). In the case of MR, the attenuation map is suitably derived by reconstructing the MR imaging data into an MR image, segmenting the MR image to identify various tissue/organ regions, and referencing an anatomical atlas to substitute appropriate attenuation values for each tissue type or organ. The possible fault in the second imaging device 14 is then detected by comparing the attenuation map of the subject derived from the CT or MR image with the reference attenuation map of the subject generated by reconstructing the emission imaging data without attenuation correction. The comparison may suitably entail spatially registering the attenuation map and the reference attenuation map, unless such spatial registration is already provided by the use of a common patient support 16, and then quantifying the difference between the two attenuation maps by a suitable difference metric such as a sum of the squares of (corresponding) voxel value differences. A value of the difference metric that exceeds some threshold is taken to indicate a possible fault in the CT- or MR-derived attenuation map. The threshold may be chosen, for example, by computing typical difference metric values for known historical patient imaging sessions in which the attenuation map is known to be correct (e.g. based on review by a radiologist or other medical professional), and setting the threshold to a value that is higher than these typical difference metric values.

At 108, the at least one electronic processor 20 is programmed to control the display device 24 to present an alert indicating the possible fault in the second imaging device 14 in response to the detection of the possible fault in the second imaging device. In the first embodiment (discussed at 106), the at least one electronic processor 20 is programmed to control the display device 24 to present an alert indicating a possible fault in the emission (i.e., first) imaging device 12 in response to detection of the possible fault in the emission imaging device. In the second embodiment (discussed at 106), the at least one electronic processor 20 is programmed to control the display device 24 to simultaneously present both the attenuation map of the subject and the reference attenuation map of the subject.

At 110, the at least one electronic processor 20 is programmed to control the database 26 to store a log entry indicating the detected possible fault in the second imaging device. The database 26 is also configured to store log data of both the first imaging device 12 and the second imaging device 14.

At 112, in response to presenting the alert (at 108), the at least one electronic processor 20 is programmed to request a user input via the at least one user input device 22 in response to presenting the alert. The user input can be indicative of whether or not clinical imaging should proceed. At 114, in response to the user input indicating clinical imaging should not proceed, reconstruction of the first imaging data is not performed. At 116, in response to the user input indicating clinical imaging should proceed, reconstruction of the first imaging data is performed to generate an image of the subject using the second imaging data to generate an attenuation map which is used in the reconstruction, and displaying the image of the subject on the display device 24.

In the operation 106, it may be noted that if the difference metric is above the threshold then it is not immediately apparent whether the fault is in the attenuation map (that is, in the CT or MR imaging modality, as assumed in the following steps 108-112) or in the reference attenuation map (that is, in the PET or SPECT imaging modality). However, as discussed elsewhere herein, analysis of variability amongst the PET or SPECT detectors may be employed to detect a problem with the PET or SPECT imaging modality so as to disambiguate such situations.

As described above, the imaging system 10 can include both the first and second imaging devices 12, 14, and likewise the imaging method 100 is performed in the context of both imaging devices. In some embodiments, the imaging system may include only one of the first or second imaging devices 12, 14, and similarly an imaging method 200 is performed in the context of one of the first and second imaging devices. The imaging method 200 is substantially similar to the imaging method 100, except as described below.

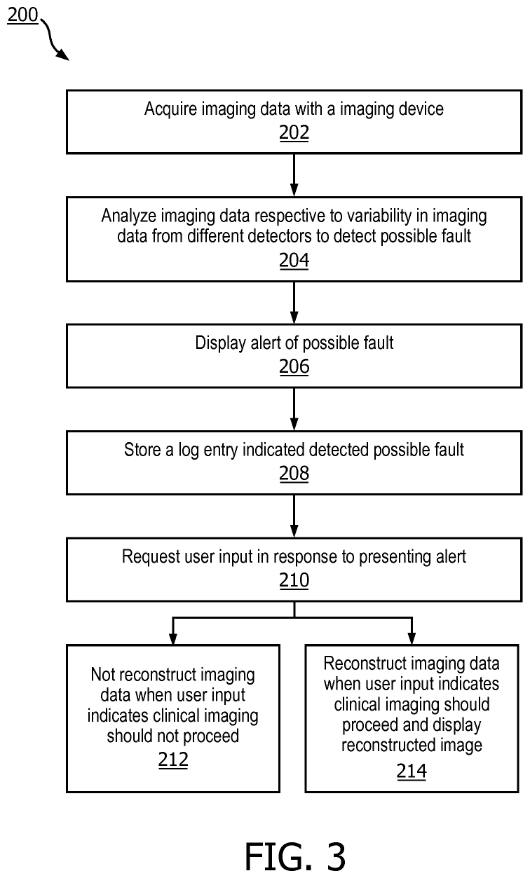

With reference to FIG. 3, an illustrative embodiment of the imaging method 200 is diagrammatically shown as a flowchart. At 202, the at least one electronic processor 20 is programmed to control or operate the imaging device 12, 14 to acquire imaging data of the subject. At 204, the at least one electronic processor 20 is programmed to analyze the imaging data of the subject respective to variability in imaging data acquired by different radiation detectors 13, 15 of the imaging device 12, 14 to detect a possible fault in the imaging device. This approach leverages the recognition that the total counts and/or count rates of different detectors, while different in general as required to generate meaningful imaging data, are usually nonetheless relatively close to each other. This similarity in count rates and/or total counts may be even closer in certain situations, e.g. in the case of multi-stage PET imaging the patient is moved stepwise through the PET scanner bore—considering two detector ring r₁ and r₂, when a certain portion of the anatomy such as the heart is centered in ring r₁ and then is centered in ring r₂, it can be expected that ring r₂ with the heart centered should have about the same total counts as the ring r₁ with the heart centered. It will be appreciated that this check is well suited for detecting a fault in the emission map acquired by a PET scanner or gamma camera, and more generally can be applied to detect a fault in a single-modality imaging system (e.g. standalone PET scanner, standalone CT scanner, or so forth). For example, in the case of a standalone CT scanner, it may be expected that the total counts acquired over a full revolution of the detector array should be about the same for all detector modules in a row of detector modules. If, to the contrary, there is large variability amongst total counts acquired by different detector modules of a single row this may indicate a fault, e.g. some detector modules may be reading low (or high). At 206, the at least one electronic processor 20 is programmed to control the display device 24 to present an alert indicating a possible fault in the imaging device 12, 14 in response to detection of the possible fault in the imaging device. The imaging method 200 may also include operations 110-116 (depicted as 208-214) as described above.

In one embodiment, the imaging device comprises the first (i.e., PET) imaging device 12 which acquires PET imaging data. The radiation detectors 13 of the PET device 12 can be arranged as one or more rings (not shown). The at least one electronic processor 20 is programmed to analyze the PET imaging data acquired by each ring to detect the possible fault based on variability in count data amongst radiation detectors of the ring exceeding a threshold variability.

In another embodiment, when the imaging device comprises the PET imaging device 12, the at least one electronic processor 20 is programmed to analyze the PET imaging data acquired by different rings to detect the possible fault based on variability in count data amongst the rings exceeding a threshold variability. In some examples, this analysis can be performed in the context of multi-station imaging by comparing the counts acquired by different PET rings with the same anatomical region (e.g., a heart in cardiac imaging) centered in the ring.

In another embodiment, the imaging device comprises the second (i.e., CT) imaging device which acquires CT imaging data. The radiation detectors 15 of the CT imaging device 14 are arranged to rotate around the subject. The at least one electronic processor 20 is programmed to analyze the CT imaging data acquired by the detectors to detect variability in imaging data acquired by the radiation detectors of the CT imaging device exceeding a threshold variability.

As noted previously, the approach for detecting a faulty attenuation map per the method of FIG. 2 does not actually distinguish whether the fault detected at operation 106 is in the attenuation map or the reference attenuation map. It will be appreciated that the approach of FIG. 3 can be used in such situations to first assess the emission image using the approach of FIG. 3. If the emission imaging data passes operation 204 (because variability amongst the different radiation detectors is sufficiently low) then the method of FIG. 2 can be applied to assess the attenuation map, and if at operation 106 the difference metric is above threshold then it can be assumed the fault is in the attenuation map.

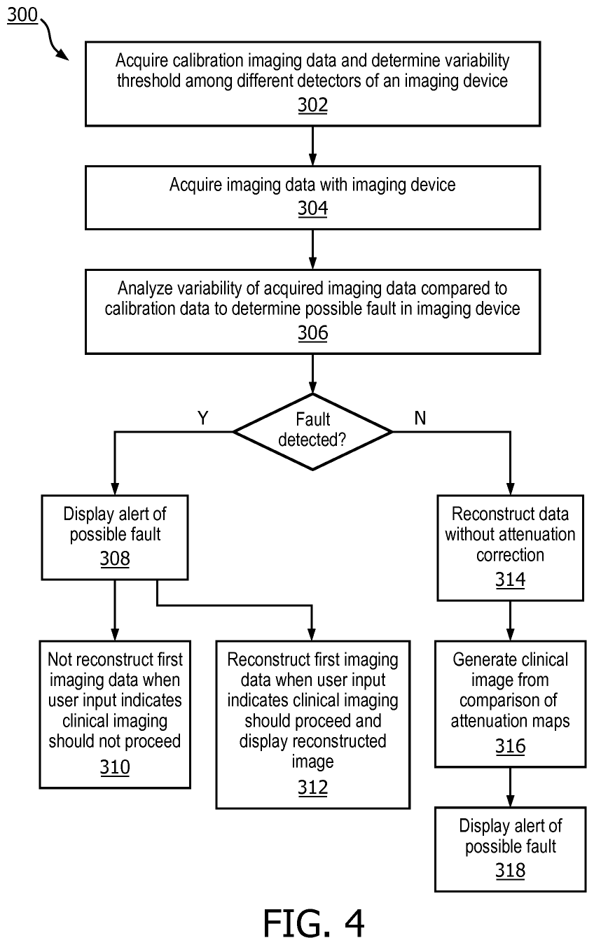

With reference to FIG. 4, another illustrative embodiment of the imaging method 300 is diagrammatically shown as a flowchart. At 302, an imaging device 12, 14, including radiation detectors 13, 15 is operated to acquire calibration imaging data of at least one calibration subject and determining a variability threshold by analyzing variability in the calibration imaging data amongst the radiation detectors of the imaging device. In some examples, the imaging device 12 includes the PET device or the gamma camera.

At 304, the imaging device 12 is operated to acquire imaging data of a subject. At 306, the at least one electronic processor 20 is programmed to analyze variability of the imaging data amongst the radiation detectors 13 of the imaging device 12 to detect a possible fault in the imaging device. In some examples, the imaging data of the subject is analyzed to detect the possible fault in the imaging device based on whether the variability in the imaging data amongst the radiation detectors of the imaging device exceeds the variability threshold of the calibration data (from 302).

At 308, when a fault is detected, an alert is displayed on the display device indicating the possible fault in the imaging device 12. In one example, at 310, after the alert is displayed, a user input indicating clinical imaging should proceed is received, and the imaging data is reconstructed to generate an image of the subject, which is displayed on the display. In another example, at 312, after the alert is displayed, a user input indicating clinical imaging should not proceed is received, and the imaging data is not reconstructed.

At 314, when a fault is not detected, the imaging data of the subject is reconstructed without attenuation correction to generate a reference attenuation map. At 316, the reference attenuation map is compared with an attenuation map to be used in reconstructing the imaging data to generate a clinical image to detect a possible fault in the attenuation map. At 318, responsive to the possible fault in the attenuation map being detected, an alert is displayed on the display device 24 indicating the possible fault in the attenuation map.

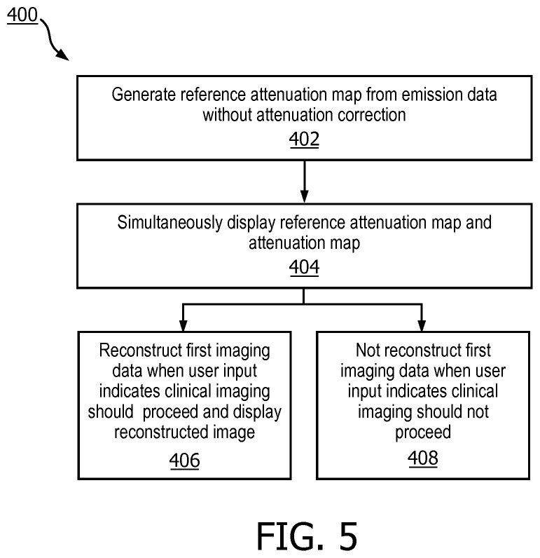

With reference to FIG. 5, another illustrative embodiment of the imaging method 400 is diagrammatically shown as a flowchart. At 402, without performing attenuation correction, emission imaging data acquired of a subject is reconstructed to generate a reference attenuation map. At 404, both the reference attenuation map and an attenuation map to be used in reconstructing the emission imaging data to generate a clinical image are simultaneously displayed on the display device 24. At 406, responsive to receiving a user input via the at least one user input device 22 indicating that clinical image reconstruction should proceed, reconstruction of the emission imaging data is performed using the attenuation map for attenuation correction to generate an attenuation-corrected image of the subject and displaying the attenuation-corrected image of the subject on the display device 24. At 408, responsive to receiving a user input via the at least one user input device 22 indicating that clinical image reconstruction should not proceed, the reconstruction using the attenuation map is not performed.

The disclosure has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. An imaging system, comprising:
a first imaging device;
a second imaging device of a different modality than the first imaging device;
a display device; and
at least one electronic processor programmed to:
operate the first imaging device to acquire first imaging data of a subject;
operate the second imaging device to acquire second imaging data of the subject;
compare the first imaging data and the second imaging data to detect a possible fault in the second imaging device; and
control the display device to present an alert indicating the possible fault in the second imaging device in response to the detection of the possible fault in the second imaging device.

2. The imaging system of claim 1, further comprising at least one user input device; and wherein the at least one electronic processor is further programmed to:
request a user input via the at least one user input device in response to presenting the alert;
responsive to the user input indicating clinical imaging should proceed, perform reconstruction of the first imaging data to generate an image of the subject using the second imaging data to generate an attenuation map which is used in the reconstruction, and displaying the image of the subject on the display device; and
responsive to the user input indicating clinical imaging should not proceed, not performing the reconstruction of the first imaging data.

3. The imaging system of claim 1, further comprising a database configured to store log data of the first and second imaging devices; wherein the at least one electronic processor is programmed to:
store a log entry indicating the detected possible fault in the second imaging device in the database.

4. The imaging system of claim 1, wherein:
the first imaging device is an emission imaging device that comprises a positron emission tomography device or a gamma camera, wherein the first imaging data is emission imaging data of the subject;
the second imaging device comprises a computed tomography imaging device or a magnetic resonance imaging device, wherein the second imaging data is CT or MRI imaging data of the subject; and
the at least one electronic processor is further programmed to:
analyze the emission imaging data for variability in count data amongst radiation detectors of the emission imaging device exceeding a threshold variability in order to detect a possible fault in the emission imaging device; and
control the display device to present an alert indicating a possible fault in the emission imaging device in response to detection of the possible fault in the emission imaging device.

5. The imaging system of claim 1, wherein:
the first imaging device is an emission imaging device that comprises a positron emission tomography device or a gamma camera, wherein the first imaging data is emission imaging data of the subject;
the second imaging device comprises a computed tomography device or a magnetic resonance imaging device, wherein the second imaging data is CT or MRI imaging data of the subject; and
the at least one electronic processor is programmed to:
reconstruct the emission imaging data without attenuation correction to generate a reference attenuation map of the subject;
derive an attenuation map of the subject from the CT or MRI imaging data;
wherein the possible fault in the second imaging device is detected by comparing the attenuation map of the subject with the reference attenuation map of the subject.

6. The imaging system of claim 5, wherein the at least one electronic processor is further programmed to control the display device to simultaneously present both the attenuation map of the subject and the reference attenuation map of the subject.

7. An imaging system, comprising:
an imaging device comprising radiation detectors;
a display device; and
at least one electronic processor programmed to:
operate the imaging device to acquire imaging data of a subject;
analyze the imaging data of the subject respective to variability in imaging data acquired by different radiation detectors of the imaging device to detect a possible fault in the imaging device; and
control the display device to present an alert indicating a possible fault in the imaging device in response to detection of the possible fault in the imaging device.

8. The imaging system of claim 7, wherein the imaging device comprises a positron emission tomography imaging device operated to acquire PET imaging data of the subject and the radiation detectors are arranged as one or more rings, and the PET imaging data acquired by each ring is analyzed to detect the possible fault based on variability in count data amongst radiation detectors of the ring exceeding a threshold variability.

9. The imaging system of claim 7, wherein the imaging device comprises a positron emission tomography imaging device operated to acquire PET imaging data of the subject and the radiation detectors are arranged as a plurality of rings, and the PET imaging data acquired by different rings is analyzed to detect the possible fault based on variability in count data amongst the rings exceeding a threshold variability.

10. The imaging system of claim 7, wherein the imaging device comprises a computed tomography imaging device operated to acquire CT imaging data of the subject and the radiation detectors are arranged to rotate around the subject, and the CT imaging data acquired by the radiation detectors is analyzed to detect variability in imaging data acquired by the radiation detectors of the CT imaging device exceeding a threshold variability.

11. The imaging system of claim 7, further comprising at least one user input device; wherein the at least one electronic processor is further programmed to:
request a user input via the at least one user input device in response to presenting the alert;
responsive to the user input indicating clinical imaging should proceed, perform reconstruction of the imaging data to generate an image of the subject and displaying the image of the subject on the display; and
responsive to the user input indicating clinical imaging should not proceed, not performing the reconstruction of the imaging data.

12. An imaging method, comprising:
receiving imaging data of a subject;
using an electronic processor, analyzing variability of the imaging data amongst the radiation detectors of the imaging device to detect a possible fault in the imaging device; and
displaying an alert on a display device indicating the possible fault in the imaging device in response to detection of the possible fault in the imaging device.

13. The imaging method of claim 12, further comprising one of:
after displaying the alert, receiving a user input indicating clinical imaging should proceed and in response reconstructing of the imaging data to generate an image of the subject and displaying the image of the subject on the display; or
after displaying the alert, receiving a user input indicating clinical imaging should not proceed and in response not reconstructing the imaging data.

14. The imaging method of claim 12, further comprising:
prior to operating the imaging device to acquire the imaging data of the subject, operating the imaging device to acquire calibration imaging data of at least one calibration subject and determining a variability threshold by analyzing variability in the calibration imaging data amongst the radiation detectors of the imaging device;
wherein the imaging data of the subject is analyzed to detect the possible fault in the imaging device based on whether the variability in the imaging data amongst the radiation detectors of the imaging device exceeds the variability threshold.

15. The imaging method of claim 12, wherein the imaging device is an emission imaging device comprising a positron emission tomography device or a gamma camera, and responsive to the analyzing not detecting the possible fault in the emission imaging device performing the further operations of:
reconstructing the imaging data of the subject without attenuation correction to generate a reference attenuation map;
comparing the reference attenuation map with an attenuation map to be used in reconstructing the imaging data to generate a clinical image to detect a possible fault in the attenuation map; and
responsive to the possible fault in the attenuation map being detected, displaying an alert on the display device indicating the possible fault in the attenuation map.

16. A non-transitory storage medium storing instructions readable and executable by at least one electronic processor operatively connected with a display device to perform an imaging method, the method comprising:
without performing attenuation correction, reconstructing emission imaging data acquired of a subject to generate a reference attenuation map;
comparing the reference attenuation map with an attenuation map to be used in reconstructing the emission imaging data to generate a clinical image to detect a possible fault in the attenuation map; and
conditional upon the comparing detecting the possible fault in the attenuation map, displaying an alert on the display device indicating the possible fault in the attenuation map.

17. The non-transitory storage medium of claim 16, wherein the imaging method further comprises:
conditional upon the comparing not detecting the possible fault in the attenuation map, reconstructing the emission imaging data to generate the clinical image using the attenuation map for attenuation correction and displaying the clinical image on the display device.

18. The non-transitory storage medium of claim 16, wherein the imaging method further comprises:
analyzing the emission imaging data of the subject respective to variability in count data amongst radiation detectors of an emission imaging device used to acquire the emission imaging data to detect a possible fault in the emission imaging device; and
displaying an alert on the display device indicating the possible fault in the emission imaging device in response to detection of the possible fault in the emission imaging device.

19. A non-transitory storage medium storing instructions readable and executable by at least one electronic processor operatively connected with a display device to perform an imaging method, the method comprising:
without performing attenuation correction, reconstructing emission imaging data acquired of a subject to generate a reference attenuation map; and
simultaneously displaying on the display device both the reference attenuation map and an attenuation map to be used in reconstructing the emission imaging data to generate a clinical image.

20. The non-transitory storage medium of claim 19 wherein the at least one electronic processor is further operatively connected with at least one user input device, and the imaging method further comprises:
responsive to receiving a user input via the at least one user input device indicating that clinical image reconstruction should proceed, performing reconstruction of the emission imaging data using the attenuation map for attenuation correction to generate an attenuation-corrected image of the subject and displaying the attenuation-corrected image of the subject on the display device; and
responsive to receiving a user input via the at least one user input device indicating that clinical image reconstruction should not proceed, not performing the reconstruction using the attenuation map.
